(19) United States
(12) Patent Application Publication
(10) Pub. No.: US 2024/0211990 A1
(43) Pub. Date: Jun. 27, 2024

(54) ADVERTISEMENT DISPLAY SYSTEM, ADVERTISEMENT DISPLAY METHOD, AND COMPUTER APPARATUS

(71) Applicant: Yusuke NAGANO, Tokyo (JP)

(72) Inventor: Yusuke NAGANO, Tokyo (JP)

(21) Appl. No.: 18/288,621

(22) PCT Filed: Jan. 19, 2022
(86) PCT No.: PCT/JP2022/001865

§ 371 Date: Oct. 27, 2023

(30) Foreign Application Priority Data
Apr. 30, 2021 (JP) 2021-077430

(51) Int. Cl. G06Q 30/0241

(52) U.S. Cl. CPC G06Q 30/0241

(57) ABSTRACT

An object of the present invention is to provide a novel advertisement display system.

An advertisement display system comprising a user terminal operated by a user, wherein the user terminal includes: a first event executer that executes a first event of any one of opening, closing, uploading, downloading, printing, and saving of digital data; and an advertisement displayer that displays an advertisement in association with execution of the first event.

### TECHNICAL FIELD

The present invention relates to a novel advertisement display system.

### BACKGROUND ART

Conventionally, advertisements such as banner advertisements are displayed on websites and the like. A user not only browses a website using a computer apparatus but also performs work using various applications installed in the computer apparatus, in many cases. Under such circumstances, for example, there is disclosed an advertisement information providing system that performs control to transmit advertisement information data during a print waiting time of a client terminal device that has output a print request (see, for example, Patent Literature 1).

### CITATION LIST

### Patent Literature

Patent Literature 1: JP 2002-157101 A

### SUMMARY OF INVENTION

### Technical Problem

An object of the present invention is to provide a novel advertisement display system.

### Solution to Problem

According to the invention, the above object is achieved by providing the following:
[1] An advertisement display system comprising a user terminal operated by a user, wherein the user terminal includes: a first event executer that executes a first event of any one of opening, closing, uploading, downloading, printing, and saving of digital data; and an advertisement displayer that displays an advertisement in association with execution of the first event;
[2] The advertisement display system according to the [1], further comprising an advertisement distribution system capable of communication connection with the user terminal, wherein the advertisement distribution system includes a first advertisement information distributer that distributes advertisement information to the user terminal in association with execution of the first event, the user terminal further includes a first advertisement information receiver that receives advertisement information from the advertisement distribution system, and the advertisement displayer displays an advertisement corresponding to the advertisement information that has been received;
[3] The advertisement display system according to the [1] or [2], further comprising an advertisement distribution system capable of communication connection with the user terminal, wherein the advertisement distribution system includes a second advertisement information distributer that distributes advertisement information to the user terminal in association with occurrence of a second event of any one of power activation, return from sleep, reaching a predetermined time, and login to the advertisement distribution system, the user terminal further includes a second advertisement information receiver that receives advertisement information from the advertisement distribution system, and the advertisement displayer displays an advertisement corresponding to the advertisement information that has been received;
[4] The advertisement display system according to the [2] or [3], wherein the user terminal further includes a user information transmitter that transmits, to the advertisement distribution system, user information related to the user, the advertisement distribution system includes a user information receiver that receives user information from the user terminal, and the first advertisement information distributer and/or the second advertisement information distributer distributes, to the user terminal, advertisement information corresponding to the user information that has been received;
[5] The advertisement display system according to any one of the [2] to [4], wherein the user terminal further includes a first event information transmitter that transmits, to the advertisement distribution system, first event information related to the first event, the advertisement distribution system includes a first event information receiver that receives first event information from the user terminal, and the first advertisement information distributer and/or the second advertisement information distributer distributes, to the user terminal, advertisement information corresponding to the first event information that has been received;
[6] The advertisement display system according to any one of the [3] to [5], wherein the user terminal further includes a second event information transmitter that transmits, to the advertisement distribution system, second event information related to the second event, the advertisement distribution system includes a second event information receiver that receives second event information from the user terminal, and the first advertisement information distributer and/or the second advertisement information distributer distributes, to the user terminal, advertisement information corresponding to the second event information that has been received;
[7] The advertisement display system according to any one of the [2] to [6], wherein the user terminal further includes: an access information storage that stores access information generated in response to access to a website; and an access information transmitter that transmits the access information to the advertisement distribution system, the advertisement distribution system includes an access information receiver that receives access information from the user terminal, and the first advertisement information distributer and/or the second advertisement information distributer distributes, to the user terminal, advertisement information corresponding to the access information that has been received;
[8] The advertisement display system according to any one of the [2] to [7], wherein the user terminal further includes an advertisement information storage that stores, when advertisement information is received from the advertisement distribution system, the advertisement information that has been received as advertisement information corresponding to an advertisement displayed in association with next or subsequent execution of the first event, and the advertisement displayer displays an advertisement corresponding to the advertisement information that has been stored in the advertisement information storage;
[9] The advertisement display system according to any one of the [1] to [8], the system further comprising a privilege granter that grants a privilege to the user in association with execution of the first event executer, the advertisement displayer, the first advertisement information distributer, and/or the second advertisement information distributer;
[10] The advertisement display system according to the [9], wherein the privilege granter grants a privilege to the user on the basis of an existence of viewing information indicating that the user has viewed the advertisement;
[11] The advertisement display system according to the [10], wherein the user terminal further includes a view information generator that generates viewing information indicating that the user has viewed the advertisement by an operation of the user during or after display of the advertisement by the advertisement displayer;
[12] An advertisement display method executed in an advertisement display system comprising a user terminal operated by a user, wherein the user terminal includes: a first event execution step of executing a first event of any one of opening, closing, uploading, downloading, printing, and saving of digital data; and an advertisement display step of displaying an advertisement in association with execution of the first event;
[13] A computer apparatus comprising: a first event executer that executes a first event of any one of opening, closing, uploading, downloading, printing, and saving of digital data; and an advertisement displayer that displays an advertisement in association with execution of the first event.

### Advantageous Effects of Invention

The invention can provide a novel advertisement display system.

### BRIEF DESCRIPTION OF DRAWINGS

FIG. 1 is a block diagram illustrating a configuration of an advertisement display system according to an embodiment of the present invention.

FIG. 2 is a block diagram illustrating a configuration of a user terminal according to an embodiment of the present invention.

FIG. 3 is a block diagram illustrating a configuration of a server apparatus according to an embodiment of the present invention.

FIG. 4 is a diagram illustrating a flowchart of an advertisement display processing according to an embodiment of the present invention.

FIG. 5 is a view illustrating an example of a display screen of an advertisement display system according to an embodiment of the present invention.

FIG. 6 is a diagram illustrating a flowchart of an advertisement distribution processing according to an embodiment of the present invention.

FIG. 7 is a diagram illustrating a flowchart of a point granting processing according to an embodiment of the present invention.

### DESCRIPTION OF EMBODIMENTS

Hereinafter, embodiments of the invention will be described. The invention, however, is not limited to the following embodiments without departing from the spirit of the invention.

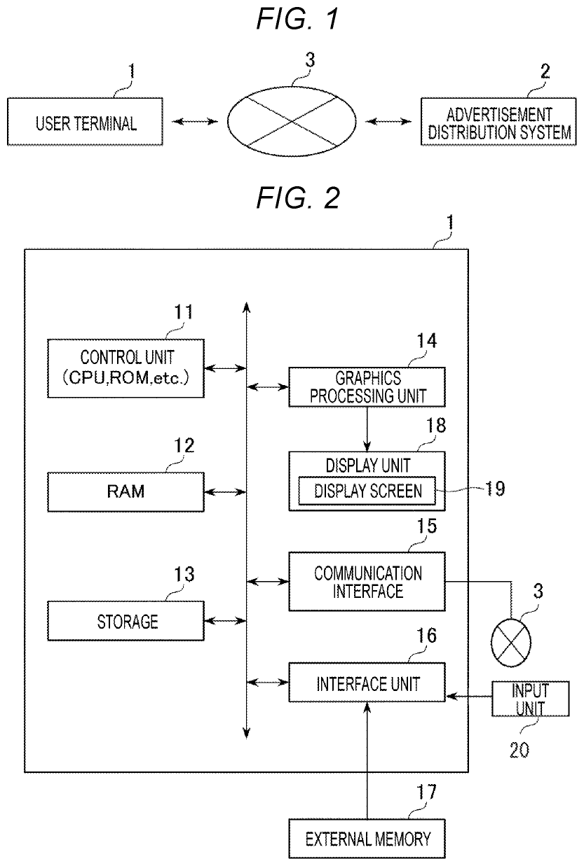

FIG. 1 is a block diagram illustrating a configuration of an advertisement display system according to an embodiment of the present invention. As illustrated, the advertisement display system includes a user terminal 1, an advertisement distribution system 2, and a communication network 3. The advertisement distribution system 2 can be communicably connected with the user terminal 1 via the communication network 3.

The user terminal 1 is operated by a user. The user terminal 1 is not particularly limited as long as it is a computer apparatus having a display screen and an input unit. The user terminal 1 may be a stationary type or a portable type that can be carried by a user when the user moves. Examples of the user terminal 1 include a conventional mobile phone, a tablet terminal, a smartphone, a desktop personal computer, a notebook personal computer, and the like. The user terminal 1 is preferably communicably connected to a printer, and when the printer receives a print request from the user terminal 1, printing is executed.

FIG. 2 is a block diagram illustrating a configuration of a user terminal according to an embodiment of the present invention. The user terminal 1 includes a control unit 11, a RAM 12, a storage 13, a graphics processing unit 14, a communication interface 15, and an interface unit 16, which are connected by an internal bus.

The control unit 11 includes a CPU and a ROM. The control unit 11 executes a program stored in the storage 13 and controls the user terminal 1. In addition, the control unit 11 includes an internal timer that clocks time. The RAM 12 is a work area of the control unit 11. The storage 13 is a storage area for storing a program and data. The control unit 11 reads a program and data from the RAM 12 and performs processing. The control unit 11 outputs a drawing command to the graphics processing unit 14 by processing the program and data loaded in the RAM 12.

The graphics processing unit 14 is connected to a display unit 18. The display unit 18 has a display screen 19. When the control unit 11 outputs the drawing command to the graphics processing unit 14, the graphics processing unit 14 outputs a video signal for displaying an image on the display screen 19. For example, the display unit 18 may be a touch panel including a touch sensor. In this case, the touch panel of the display unit 18 functions as an input unit.

The communication interface 15 can be connected to the communication network 3 wirelessly or by wire, and can transmit and receive data to and from the server apparatus 2a via the communication network 3. Data received via the communication interface 15 is loaded into the RAM 12, and arithmetic processing is performed by the control unit 11. An external memory 17 (for example, an SD card or the like) and an input unit 20 are connected to the interface unit 16.

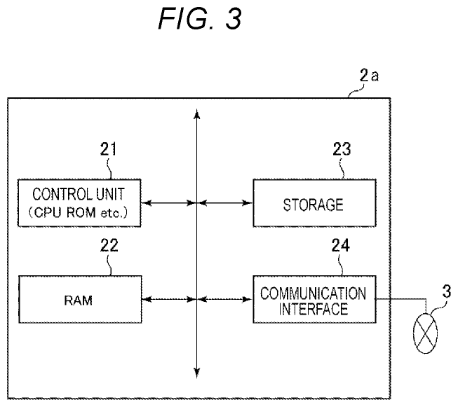

The advertisement distribution system 2 includes at least one server apparatus. The advertisement distribution system 2 may further include a computer apparatus other than the server apparatus. FIG. 3 is a block diagram illustrating a configuration of a server apparatus according to an embodiment of the present invention. The server apparatus 2a includes at least a control unit 21, a RAM 22, a storage 23, and a communication interface 24, which are connected by an internal bus.

The control unit 21 includes a CPU and a ROM, executes a program stored in the storage 23, and controls the server apparatus 2a. In addition, the control unit 21 includes an internal timer that clocks time. The RAM 22 is a work area of the control unit 21. The storage 23 is a memory area for saving programs and data. The control unit 21 reads a program and data from the RAM 22, and performs program execution processing on the basis of information or the like received from the user terminal 1.

The communication interface 24 can be connected to the communication network 3 wirelessly or by wire, and can transmit and receive data to and from the user terminal 1 via the communication network 3. Data received via the communication interface 24 is loaded into the RAM 22, and arithmetic processing is performed by the control unit 21.

In the advertisement display system of the present invention, to start using the advertisement display system, it is preferable that a user registers information related to the user (hereinafter, referred to as user information) in the advertisement distribution system 2. The user information can include information such as a name, gender, date of birth, age, occupation, and address of the user. The user can input the user information by operating the user terminal 1.

The user information is preferably transmitted to and stored in the advertisement distribution system 2. Hereinafter, a function of the advertisement distribution system 2 is assumed to be executed in the server apparatus 2a included in the advertisement distribution system 2. When the server apparatus 2a receives the user information, it is preferable that information such as a user ID that can identify the user and a password used when logging in to the advertisement distribution system 2 be stored in a user management table, in association with the user information.

Hereinafter, the advertisement display system of the present invention will be described in the order of an advertisement display processing, an advertisement distribution processing, and a point granting processing. The order in which each processing is performed and the order in which steps in each processing are performed are not particularly limited, and can be appropriately designed. In addition, only some steps in each process may be performed.

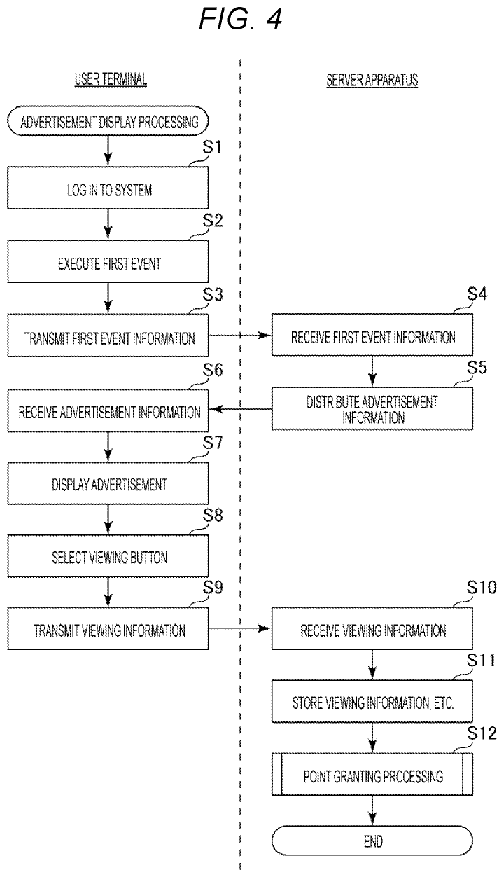

First, the advertisement display processing will be described. FIG. 4 is a diagram illustrating a flowchart of an advertisement display processing according to an embodiment of the present invention. The user operates the user terminal 1 to log in to the advertisement distribution system 2 of the present invention (step S1). When logging in, the user inputs a user ID and a password to the user terminal 1.

Note that, here, the login to the advertisement display system is performed before an execution of a first event, but the timing of the login to the advertisement display system is not particularly limited as long as it is before an advertisement information is distributed from the advertisement distribution system 2 (server apparatus 2a) to the user terminal 1. For example, the user may log in to the advertisement display system immediately after executing the first event.

After the login, the user executes the first event by operating the user terminal 1 using an application installed in the user terminal 1 (step S2). Here, the first event is any of opening, closing, uploading, downloading, printing, and saving of digital data.

The opening of the digital data corresponds to, for example, selecting a data file to display the content of the data or bring the data into an editable state. The closing of the digital data corresponds to, for example, closing the data from a state in which the content of the data is displayed or editable to a state in which the content of the data is not displayed.

The uploading of the digital data corresponds to, for example, transmitting data to another computer apparatus via the communication network 3. Not only transmission of an attached file by a mailer having an electronic mail transmission/reception function but also transmission of a mail text corresponds to upload of digital data. The downloading of the digital data corresponds to, for example, receiving data to another computer apparatus via the communication network 3.

The printing of the digital data corresponds to, for example, issuing a print request command to a printer capable of communication connection with the user terminal 1, and printing the content of the digital data on a paper medium by the printer. The storage of the digital data corresponds to, for example, storing data edited using an application in the user terminal 1 or the cloud.

For example, a case where the first event is printing will be described. In step S2, when a button to print the digital data is selected in the user terminal 1, a print request is transmitted to a printer connected to the user terminal 1. When the printer receives the print request, the contents of the data are printed on a paper medium.

On the other hand, in step S2, when the button to print the digital data is selected in the user terminal 1, the information related to the first event (hereinafter, referred to as first event information) is transmitted from the user terminal 1 to the server apparatus 2a (step S3). The server apparatus 2a receives the first event information (step S4). Then, an advertisement information is distributed from the server apparatus 2a to the user terminal 1 (step S5), and the advertisement information is received in the user terminal 1 (step S6).

The first event information is not particularly limited as long as it is information related to the first event. For example, the first event information can include a flag indicating that printing has been executed, the number of printed sheets, a printing time, a printer name, a printer type, a color setting at the time of printing (color printing, monochrome printing, etc.), printer information acquired from the printer (consumables level, total number of printed sheets, firmware version, etc.), an application name, a file name, and the like.

The first event information received by the server apparatus 2a in step S4 may be stored in a user management table in association with the user ID.

In step S5, the advertisement information corresponding to the first event information received in step S4 is distributed. For example, in a case where printing is performed at a time before lunch time, advertisement information of a dish suitable for lunch may be distributed.

Furthermore, in step S5, advertisement information corresponding to the user information may be distributed. For example, in a case where the user information includes the address of the user, advertisement information of a restaurant having a store within a predetermined range from the address of the user may be distributed.

Furthermore, in step S5, advertisement information corresponding to past access to a website by the user terminal 1 may be distributed. For example, in a case where the number of accesses to a food-related website is large, food-related advertisement information may be distributed, and in a case where the number of accesses to a sports-related website is large, sporting goods related advertisement information may be distributed.

Examples of a method for distributing advertisement information corresponding to past access to a website by the user terminal 1 include the following method. In step S2, when the first event is executed in the user terminal 1, information regarding a past access history (for example, cookie) to a website stored in the user terminal 1 is transmitted from the user terminal 1 to the server apparatus 2a. Then, the server apparatus 2a receives the information regarding a past access history to a website.

In the server apparatus 2a, advertisement information of a plurality of fields is stored, advertisement information having a predetermined relationship with the first event information, the user information, and/or the information regarding the access history is specified, and the specified advertisement information can be distributed to the user terminal 1.

When the advertisement information is received in step S6, an advertisement window for displaying an advertisement is displayed on the user terminal 1, and the advertisement is displayed (step S7).

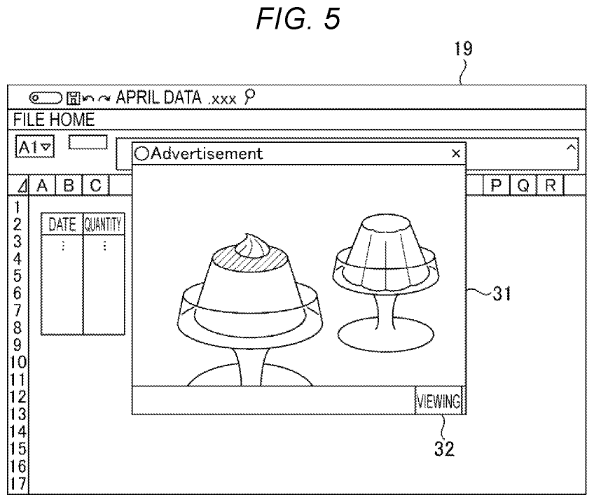

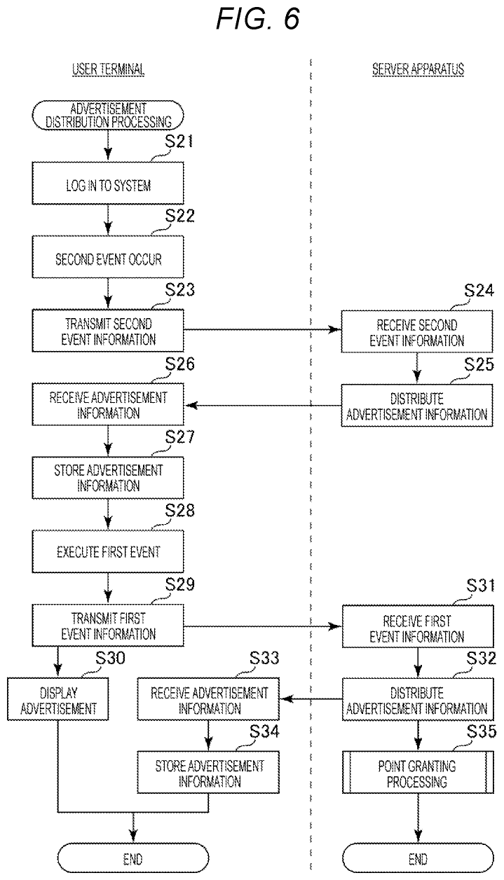

FIG. 5 is a view illustrating an example of a display screen of an advertisement display system according to an embodiment of the present invention. In FIG. 5, on the display screen 19 of the user terminal 1, an advertisement window 31 is displayed on digital data to be printed, and a food-related advertisement is displayed.

When the advertisement information is received in step S6, the advertisement window 31 is displayed on the display screen 19 as illustrated in FIG. 5 in step S7. Then, an advertisement corresponding to the advertisement information received in step S6 is displayed in the advertisement window 31. When a predetermined time elapses from the display of the advertisement, the advertisement window 31 is closed, and the display of the advertisement ends.

In the advertisement window 31, a viewing button 32 for proving that the user has viewed the advertisement is displayed outside or inside the area where the advertisement is displayed, and the user selects the viewing button 32 by operating the user terminal 1 (step S8).

In FIG. 5, the viewing button 32 is displayed at the lower right of the advertisement window 31. In step S8, the user selects the viewing button 32 by operating the user terminal 1.

In a case where the user does not select the viewing button 32, no point is granted or the amount of points to be granted is reduced in the point granting processing to be described later. Note that, here, display of the viewing button 32 in the advertisement window 31 and selection by the user are executed during display of the advertisement, but may be executed before display of the advertisement or may be executed after display of the advertisement.

When the viewing button 32 is selected by the user, viewing information indicating that the advertisement has been viewed on the user terminal 1 is generated, and the viewing information is transmitted from the user terminal 1 to the server apparatus 2a (step S9). The server apparatus 2a receives the viewing information (step S10), and stores information indicating that the viewing information has been received and the reception time of the viewing information in the user management table in association with the user ID (step S11).

The viewing information is not particularly limited as long as it is information indicating that the advertisement has been viewed. The viewing information can include information indicating that the advertisement has been viewed, a type of the displayed advertisement, a length of the display time of the displayed advertisement, and the like.

When the viewing information and the like are stored in the server apparatus 2a, next, the point granting processing for granting a point to the user is executed (step S12). Details of the point granting processing will be described later. By steps S1 to S12, the advertisement display processing ends.

In the above description, an embodiment has been described in which advertisement information is distributed when the first event information is received in the server apparatus 2a, and an advertisement corresponding to the advertisement information is displayed on the display screen 19 of the user terminal 1. However, the advertisement information may be distributed at a timing different from a timing when the first event information is received. In addition, the advertisement displayed on the display screen 19 of the user terminal 1 may not correspond to the advertisement information immediately after being received from the server apparatus 2a.

Hereinafter, an embodiment in which advertisement information is distributed when the second event information is received in the server apparatus 2a will be described. In addition, an embodiment in which distributed advertisement information is stored in the user terminal 1, and an advertisement corresponding to the advertisement information that has been stored is displayed on the display screen 19 of the user terminal 1 in association with execution of the next or subsequent first event will be described.

FIG. 6 is a diagram illustrating a flowchart of an advertisement distribution processing according to an embodiment of the present invention.

First, the user operates the user terminal 1 to log in to the advertisement distribution system 2 of the present invention (step S21). As the description regarding the login to the advertisement distribution system 2, the above description of the advertisement display processing can be adopted within a necessary range.

Next, in the user terminal 1, a second event occurs (step S22). Here, the second event may be any of power activation, return from sleep, reaching a predetermined time, and login to the advertisement distribution system 2, of the user terminal 1.

The power activation of the user terminal 1 corresponds to, for example, that the user turns on the power of the user terminal 1 and activates the user terminal 1. The return from sleep corresponds to, for example, a state in which the user terminal 1 consumes normal power after the user terminal 1 goes into a sleep state with less power consumption due to elapse of a predetermined time without an operation input to the user terminal 1 or due to a selection operation of the user.

The reaching a predetermined time corresponds to a state in which it is regarded that a predetermined time has been reached by an internal timer included in the user terminal 1. The login to the advertisement distribution system 2 corresponds to the login to the advertisement distribution system 2 of the present invention by the user operating the user terminal 1.

For example, a case where the second event is reaching a predetermined time will be described. In step S22, when a predetermined time is reached while the user is logged in to the advertisement distribution system 2, information on the second event (hereinafter, referred to as second event information) is transmitted from the user terminal 1 to the server apparatus 2a (step S23). Then, the server apparatus 2a receives the second event information (step S24). Next, when the first event is executed on the user terminal 1 next or subsequently, advertisement information to be displayed as an advertisement is distributed from the server apparatus 2a to the user terminal 1 (step S25). When the advertisement information is received by the user terminal 1 (step S26), the advertisement information that has been received is stored as advertisement information for displaying an advertisement next or subsequently (step S27).

The second event information is not particularly limited as long as it is information related to the second event. For example, the second event information can include information indicating that a predetermined time has been reached, a time when the predetermined time has been reached, and the like.

The second event information received by the server apparatus 2a in step S24 may be stored in the user management table in association with the user ID.

In step S25, the advertisement information corresponding to the second event information received in step S24 is distributed. For example, in a case where the time when the predetermined time has been reached is a time at night, advertisement information of a bath additive expressing a relaxation effect may be distributed.

Furthermore, in step S25, advertisement information corresponding to the user information and/or the information regarding the access history may be distributed.

In step S27, it may be done as the advertisement information stored in the user terminal 1 before the advertisement information is received in step S26 is deleted, and the advertisement information that has been received in step S26 is stored. The number of pieces of advertisement information stored in the user terminal 1 is not particularly limited, and one or more pieces of advertisement information can be stored.

In a case where the first event is executed after the advertisement information is stored in the user terminal 1 in step S27 (step S28), that is, in a case where the button to print the digital data is selected here, the first event information is transmitted from the user terminal 1 to the server apparatus 2a (step S29). Then, in the user terminal 1, the advertisement window 31 for displaying an advertisement is displayed on the user terminal 1, and the advertisement is displayed (step S30).

The advertisement information displayed in step S30 is the advertisement information that has been stored in the user terminal 1 in step S27.

Alternatively, in a case where two or more pieces of advertisement information are stored in the user terminal 1, any one of the pieces of advertisement information stored in the user terminal 1 may be displayed in step S30.

As an embodiment of the advertisement in step S30, the above description of the advertisement display processing can be adopted within a necessary range.

While the advertisement is displayed on the user terminal 1 in step S30, the first event information transmitted to the server apparatus 2a in step S29 is received by the server apparatus 2a (step S31). Next, the advertisement information is distributed from the server apparatus 2a to the user terminal 1 (step S32), and the advertisement information is received in the user terminal 1 (step S33). Then, the advertisement information is stored in the user terminal 1 (step S34).

The first event information received by the server apparatus 2a in step S31 may be stored in the user management table in association with the user ID.

Furthermore, in step S32, advertisement information corresponding to the user information, the first event information, the second event information, and/or the information regarding the access history may be distributed. For the advertisement information distributed in step S32, the descriptions in the advertisement display processing and in step S25 can be adopted within a necessary range.

On the other hand, after the advertisement information is distributed from the server apparatus 2a to the user terminal 1, the server apparatus 2a executes the point granting processing for granting a point to the user (step S35). Details of the point granting processing will be described later. By steps S21 to S35, the advertisement distribution processing ends.

In the above description, an embodiment in which the advertisement information is distributed when the second event information is received and when the first event information is received has been described. However, an embodiment in which the advertisement information is distributed at any timing when the second event information is received or when the first event information is received may be adopted.

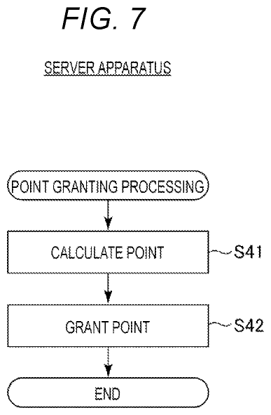

Next, the point granting process will be described. FIG. 7 is a diagram illustrating a flowchart of a point granting processing according to an embodiment of the present invention.

When the storage of the viewing information in step S11 of the advertisement display processing and/or the distribution of the advertisement information in step S32 of the advertisement distribution processing are finished, the server apparatus 2a calculates a point to be granted to the user (step S41).

The point to be granted to the user can be calculated on the basis of the viewing information or the like stored in the user management table in step S11 of the advertisement display processing. For example, in a case where the reception time of the viewing information is a predetermined time, more points to be granted may be calculated. Alternatively, for example, as an amount of points owned by the user stored in the user management table to be described later increases, more points to be granted may be calculated. In addition, a point corresponding to a length of the display time of the advertisement viewed by the user may be calculated.

When the point is calculated in step S41, the point is granted to the user (step S42), and the point granting process ends. The point granted to the user is stored in the user management table in association with the user ID. The points owned by the user are preferably browsable by the user by logging in to the advertisement display system and/or the advertisement distribution system 2.

Alternatively, the information regarding the point granted to the user may be transmitted from the server apparatus 2a to the user terminal 1 and stored in the user terminal 1.

The user can exchange the owned point for another article. Other articles may be tangible or intangible. In addition, other articles may be selectable by the user or may not be selectable by the user. For example, the user can exchange the owned point for an ink cartridge for a printer, printing paper, pen, or the like at the user's choice.

The point granting process may be performed at a timing other than the above timing. For example, it is also possible to adopt an embodiment in which a point is granted to the user in association with execution of the first event, display of an advertisement, distribution of advertisement information associated with execution of the first event, and/or distribution of advertisement information associated with execution of the second event.

In a case where a point is granted to the user in association with the advertisement is displayed, information indicating that the advertisement is displayed (hereinafter, referred to as advertisement display information) may be transmitted from the user terminal 1 to the server apparatus 2a.

Then, the point granting processing may be performed when the first event information and/or the advertisement display information is received by the server apparatus 2a and/or when the advertisement information is distributed from the server apparatus 2a. Furthermore, in this case, when the viewing information is also stored in the user management table, more points to be granted may be calculated.

Furthermore, in the above description, an embodiment in which a point is granted to the user based on the user viewing of the advertisement has been described. However, what is granted to the user is not limited to the point, and may be anything that is a privilege for the user. For example, the privilege granted to the user may be a tangible or intangible article.

With the present invention, it is possible to provide a novel advertisement display system in which a first event of any one of opening, closing, uploading, downloading, printing, and saving of digital data is executed in a user terminal, and an advertisement is displayed in association with execution of the first event.

With the present invention, since the advertisement information is distributed from the advertisement distribution system to the user terminal in association with the execution of the first event, the advertisement information is distributed to the user terminal every time the first event is executed.

With the present invention, since the advertisement information is distributed to the user terminal as the second event of any one of the power activation, the return from sleep, the reaching a predetermined time, and/or the login to the advertisement distribution system occurs in the user terminal, the advertisement information is distributed to the user terminal every time the second event occurs.

With the present invention, since the user information, the first event information, the second event information, and/or the advertisement information corresponding to an access of the user to a website are distributed to the user terminal, the advertisement information matching an attribute and a preference of the user can be distributed to the user terminal.

With the present invention, when the user terminal receives the advertisement information from the advertisement distribution system, the advertisement information that has been received is stored as the advertisement information corresponding to the advertisement displayed in association with the next or subsequent execution of the first event, and the advertisement corresponding to the advertisement information that has been stored is displayed. Therefore, it is possible to change the displayed advertisement each time the first event is executed or the second event occurs.

With the present invention, since a privilege is granted to the user in association with the execution of the first event, the display of the advertisement, the advertisement distribution accompanying the execution of the first event, and/or the advertisement information distribution accompanying the execution of the second event, it is possible to encourage the user to actively execute the first event, the display of the advertisement, and/or the execution of the second event.

With the present invention, since the privilege is granted to the user on the basis of an existence of the viewing information indicating that the user has viewed the advertisement, the privilege can be granted to the user who has viewed the advertisement. In addition, with the present invention, since the viewing information indicating that the user has viewed the advertisement is generated by the operation of the user during or after the display of the advertisement, the privilege can be granted to the user who has viewed the advertisement.

### REFERENCE SIGNS LIST

1: user terminal, 2: advertisement distribution system, 2a: server apparatus, 3: communication network, 11: control unit, 12: RAM, 13: storage, 14: graphics processing unit, 15: communication interface, 16: interface unit, 17: external memory, 18: display unit, 19: display screen, 20: input unit, 21: control unit, 22: RAM, 23: storage, 24: communication interface, 31: advertisement window, 32: viewing button.

1. An advertisement display system comprising a user terminal operated by a user, wherein
the user terminal includes:
a first event executer that executes a first event of any one of opening, closing, uploading, downloading, printing, and saving of digital data; and
an advertisement displayer that displays an advertisement in association with execution of the first event.

2. The advertisement display system according to claim 1, further comprising an advertisement distribution system capable of communication connection with the user terminal, wherein
the advertisement distribution system includes
a first advertisement information distributer that distributes advertisement information to the user terminal in association with execution of the first event,
the user terminal further includes
a first advertisement information receiver that receives advertisement information from the advertisement distribution system, and
the advertisement displayer displays an advertisement corresponding to the advertisement information that has been received.

3. The advertisement display system according to claim 1, further comprising an advertisement distribution system capable of communication connection with the user terminal, wherein
the advertisement distribution system includes
a second advertisement information distributer that distributes advertisement information to the user terminal in association with occurrence of a second event of any one of power activation, return from sleep, reaching a predetermined time, and login to the advertisement distribution system,
the user terminal further includes
a second advertisement information receiver that receives advertisement information from the advertisement distribution system, and
the advertisement displayer displays an advertisement corresponding to the advertisement information that has been received.

4. The advertisement display system according to claim 2, wherein
the user terminal further includes
a user information transmitter that transmits, to the advertisement distribution system, user information related to the user,
the advertisement distribution system includes
a user information receiver that receives user information from the user terminal, and
the first advertisement information distributer distributes, to the user terminal, advertisement information corresponding to the user information that has been received.

5. The advertisement display system according to claim 2, wherein
the user terminal further includes
a first event information transmitter that transmits, to the advertisement distribution system, first event information related to the first event,
the advertisement distribution system includes
a first event information receiver that receives first event information from the user terminal, and
the first advertisement information distributer distributes, to the user terminal, advertisement information corresponding to the first event information that has been received.

6. The advertisement display system according to claim 3, wherein
the user terminal further includes
a second event information transmitter that transmits, to the advertisement distribution system, second event information related to the second event,
the advertisement distribution system includes
a second event information receiver that receives second event information from the user terminal, and
the second advertisement information distributer distributes, to the user terminal, advertisement information corresponding to the second event information that has been received.

7. The advertisement display system according to claim 2, wherein
the user terminal further includes:
an access information storage that stores access information generated in response to access to a website; and
an access information transmitter that transmits the access information to the advertisement distribution system,
the advertisement distribution system includes
an access information receiver that receives access information from the user terminal, and
the first advertisement information distributer distributes, to the user terminal, advertisement information corresponding to the access information that has been received.

8. The advertisement display system according to claim 2, wherein
the user terminal further includes
an advertisement information storage that stores, when advertisement information is received from the advertisement distribution system, the advertisement information that has been received as advertisement information corresponding to an advertisement displayed in association with next or subsequent execution of the first event, and
the advertisement displayer displays an advertisement corresponding to the advertisement information that has been stored in the advertisement information storage.

9. The advertisement display system according to claim 1, the system further comprising
a privilege granter that grants a privilege to the user in association with execution of the first event executer, and/or the advertisement displayer.

10. The advertisement display system according to claim 9, wherein the privilege granter grants a privilege to the user on the basis of an existence of viewing information indicating that the user has viewed the advertisement.

11. The advertisement display system according to claim 10, wherein
the user terminal further includes
a view information generator that generates viewing information indicating that the user has viewed the advertisement by an operation of the user during or after display of the advertisement by the advertisement displayer.

12. An advertisement display method executed in an advertisement display system comprising a user terminal operated by a user, wherein
the user terminal includes:
executing a first event of any one of opening, closing, uploading, downloading, printing, and saving of digital data; and
displaying an advertisement in association with execution of the first event.

13. A computer apparatus comprising:
a first event executer that executes a first event of any one of opening, closing, uploading, downloading, printing, and saving of digital data; and
an advertisement displayer that displays an advertisement in association with execution of the first event.

14. The advertisement display system according to claim 3, wherein
the user terminal further includes
a user information transmitter that transmits, to the advertisement distribution system, user information related to the user,
the advertisement distribution system includes
a user information receiver that receives user information from the user terminal, and
the second advertisement information distributer distributes, to the user terminal, advertisement information corresponding to the user information that has been received.

15. The advertisement display system according to claim 3, wherein
the user terminal further includes
a first event information transmitter that transmits, to the advertisement distribution system, first event information related to the first event,
the advertisement distribution system includes
a first event information receiver that receives first event information from the user terminal, and
the second advertisement information distributer distributes, to the user terminal, advertisement information corresponding to the first event information that has been received.

16. The advertisement display system according to claim 3, wherein
the user terminal further includes:
an access information storage that stores access information generated in response to access to a website; and
an access information transmitter that transmits the access information to the advertisement distribution system,
the advertisement distribution system includes
an access information receiver that receives access information from the user terminal, and
the second advertisement information distributer distributes, to the user terminal, advertisement information corresponding to the access information that has been received.

17. The advertisement display system according to claim 3, wherein
the user terminal further includes
an advertisement information storage that stores, when advertisement information is received from the advertisement distribution system, the advertisement information that has been received as advertisement information corresponding to an advertisement displayed in association with next or subsequent execution of the first event, and
the advertisement displayer displays an advertisement corresponding to the advertisement information that has been stored in the advertisement information storage.

18. The advertisement display system according to claim 2, the system further comprising
a privilege granter that grants a privilege to the user in association with execution of the first event executer, the advertisement displayer, and/or the first advertisement information distributer.

19. The advertisement display system according to claim 3, the system further comprising
a privilege granter that grants a privilege to the user in association with execution of the first event executer, the advertisement displayer, and/or the second advertisement information distributer.
